(19) United States
(12) Patent Application Publication
(10) Pub. No.: US 2001/0007234 A1
(43) Pub. Date: Jul. 12, 2001

(54) Apparatus and method for real time adjustment of a fifth wheel associated with an agricultural machine

(75) Inventor: Timothy R. Scheetz, Nauvoo, IL (US)

Correspondence Address: Kevin M. Kercher, Esq., Husch & Eppenberger, LLC, Suite 1400, 401 Main Street, Peoria, IL, 61602-1241, US

(73) Assignee: Scheetz Technology, Inc.

(21) Appl. No.: 09/771,828

(22) Filed: Jan. 29, 2001

Related U.S. Application Data
(63) Continuation-in-part of application No. 09/253,198, filed on Feb. 19, 1999, now abandoned.

(51) Int. Cl. A01C 7/00; A01C 23/00

(52) U.S. Cl. 111/186; 111/123; 111/903; 172/2; 172/677

(57) ABSTRACT

A tractor that can pull a wide variety of equipment such as that for tilling, seeding and fertilizing of field crops. The equipment can also include reservoirs for containing large quantities of seeds and fertilizers such as liquid manure. As tilling and fertilizing progresses these materials as dispensed changing the weight distribution on the tractor. The change can be compensated for during use by sensing weight and adjusting the position of the machine connecting structure in response thereto, such as a fifth wheel of the tractor, in real-time, to generally equalize weight distribution.

### APPLICATION CROSS-REFERENCE

This application is a continuation-in-part of co-pending U.S. application Ser. No. 09/253,198, filed Feb. 19, 1999.

### FIELD OF THE INVENTION

This invention relates agricultural machinery and methods. In particular, it relates to real time adjustment of a fifth wheel associated with an agricultural apparatus to generally equalize weight distribution.

### BACKGROUND AND SUMMARY OF THE INVENTION

Conventional methods of planting and tilling field crops require several passes over the field. If soil conditions are not favorable, an inordinate amount of time is spent cleaning the machinery. Furthermore, the time available to work the soil is roughly five (5) days. The present invention enables a farmer to take care of all functions in one pass over the soil, saving valuable time and fuel. Handling several operations requires several pieces of heavy machinery. Under normal circumstances the weight would unduly pack the soil. The present invention uses supporting tracks or wheels to distribute the weight without unduly packing the soil. Some of the supporting tracks or wheels may be driven. Nitrogen fertilizes the soil. The nitrogen in manure, however, is not as concentrated as the nitrogen in an ammonia fertilizer. Thus, any apparatus depositing liquid manure must carry more liquid manure than it would carry ammonia fertilizer. The weight, if not distributed, may harden the soil. The present invention distributes the weight, enabling the farmer to carry greater weight over the field without making the soil unsuitable for planting. Other problems have arisen concerning incorporating liquid manure into the soil. For example, spraying the liquid manure on top of the soil, broadcasting, gives the field an extremely unpleasant odor. The present invention allows one to attach tanks and other devices, such as plows, to incorporate liquid manure into the soil by injection while the soil is being tilled, thus exposing more soil to the manure and reducing the odor. These additional devices add weight to the complete apparatus. Even though much weight is added, the present invention distributes the weight, minimizing compaction of the soil.

Conventional devices exist to accomplish two farming operations in the same pass. U.S. Pat. No. 5,558,471 describes an apparatus that cuts the soil and injects a chemical while being pulled by a tractor. The chemical comes from a tube attached near the cutting device. Another device, known as the Seed Hawk, is an attachment that fertilizes, seeds and firms the soil. The Seed Hawk has a fracturing knife that goes into the soil and deposits fertilizer coming from a drop tube attached to the fracturing knife. At the same time another fracturing knife attached to a seed drop tube follows the first fracturing knife and deposits seed into the soil. A wheel follows the fracturing knives and firms the soil. Other configurations perform the same functions, such as the Conserva Pak attachment. It operates in much the same manner as the Seed Hawk. Devices like the Seed Hawk and the Conserva Pak attachment can be connected to the present invention to perform the fertilizing, seeding and firming operations while carrying the tanks of seed and fertilizer, allowing a farmer to complete as much of the field in one pass as supplies will allow.

Conventional devices cannot carry the weight of the equipment without unduly packing the soil. This method distributes the weight over wheels or tracks to avoid this problem. The present invention's cab-forward design allows room for a movable fifth wheel, which enables an operator to change the location of the fifth wheel to accommodate changes in weight distribution as seed and chemicals are used. German patent DE 42 17 249 describes a farm tractor with a tracklaying undercarriage and a place for a fifth wheel. It does not disclose using a modified cab of a semitractor with a movable fifth wheel or the tractor pulling components for seeding, tilling and spreading chemicals in one pass.

Problems have also arisen concerning the application of liquid manure. Broadcasting the manure produces a much more offensive odor than injecting it. In an article entitled “Manure Applicators” in the December 1996 issue of Successful Farming (p. 28), farmers rated the odor of a field where manure was applied to the surface and a field where manure was injected into the soil. The farmers indicated that the injected field produced a much less pungent odor. The present invention injects liquid manure into the soil while it is being tilled.

Furthermore, according to the same article, 20% of the nitrogen may be lost if manure stays on the surface of the ground for 24 hours or more without being incorporated (p.28, 32). Injecting the manure into the soil during tilling prevents nitrogen from escaping, increasing the efficiency of the fertilizer to where only approximately 5% of the nitrogen escapes (p.32). Further, the present invention permits an apparatus to carry a large amount of liquid manure and use it in a one-pass process. The invention may also include mechanisms, which distribute the weight of the combined equipment and load to minimize the compacting of the treated soil. The present invention injects liquid manure into the soil, conserving nitrogen.

Thus, the present invention carries several types of equipment on one apparatus, the drivers distributing the weight. Several farming operations are performed at one time (tilling, seeding and fertilizing), saving valuable time and fuel. Lastly, the present invention enables a farmer to incorporate liquid manure while tilling, retaining nitrogen and minimizing the smell at the same time. I am aware of the following patents and publications, the disclosures are herein incorporated by reference: 1) U.S. Pat. No. 5,558,471, 2) the Seed Hawk sales brochure, 3) “Manure Applicators” in the December 1996 issue of Successful Farming (p. 28-33), 4) German patent DE 42 17 249, 5) the Conserva Pak sales brochure, 6) U.S. Pat. No. 3,428,334 and 7) U.S. Pat. No. 5,677,667.

An aspect of the present invention is to provide a method and apparatus to till soil, seed it, fertilize it and firm it simultaneously.

Another aspect of the present invention is to provide an apparatus with a cab-forward design to allow a fifth wheel to adjust automatically as fertilizer and seed are used.

Another aspect of this invention is to provide a means to apply herbicides while seeding and firming the soil.

Yet another aspect of this invention is to provide means to apply liquid manure or other fertilizers to the soil while tilling and seeding.

Still another aspect of this invention is to provide an apparatus for performing several farming functions in one pass using the following: a cab with an engine; a supporting frame; a fifth wheel connected to the cab and the supporting frame; drivers connected to the cab; and drivers supporting the supporting frame. In this manner the drivers spread the weight of the apparatus lessening the degree the soil is compacted as the apparatus travels over the soil.

Yet another aspect for this invention is to provide a method for treating the soil including the following: means to till, seed and spread liquid manure on the soil; at least one tank for holding liquid manure connected to the device to inject liquid manure, and at least one tank holding seed connected to the device to seed the soil, filling all tanks, and driving the apparatus over the soil, performing several operations at one time.

A further aspect of this invention is to provide a method for treating soil including: providing a device for pulling, a tank for liquid manure, a tank for seed, a device to deposit seed, a device to inject liquid manure, a fifth wheel, and a device to till the soil. One then connects the seed tank to the device for depositing seed and connects the liquid manure tank to the device that deposits it. One connects the pulling device to a fifth wheel and loads all farming devices on a supporting frame connected to the fifth wheel. Once the tanks are filled, one pulls the apparatus over the soil, performing several farming operations at one time.

The above listing of aspects are merely illustrative and should not be deemed as all-inclusive. These, and other aspects and advantages of the present invention, will become apparent, as the same becomes better understood from the following detailed description when taken in conjunction with the accompanying drawings.

### BRIEF DESCRIPTION OF THE DRAWINGS

FIG. 1 is a side view of one embodiment of the present invention;

FIG. 2 is a side view of another embodiment of the present invention in which different chemical tanks are attached to the rear of the apparatus;

FIG. 3 is a schematic diagram of a hydraulic system;

FIG. 4 is a schematic diagram of an hydraulic system to be used to control the fifth wheel; and

FIG. 5 is a schematic diagram showing an embodiment having a tank, which may be attached on top of the cab.

### DETAILED DESCRIPTION

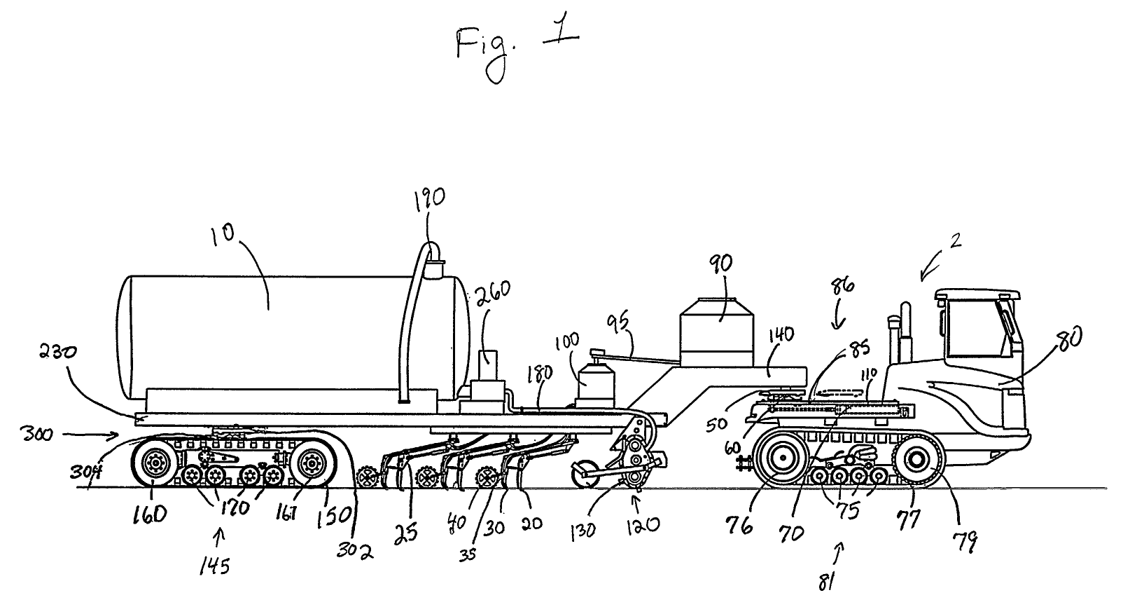

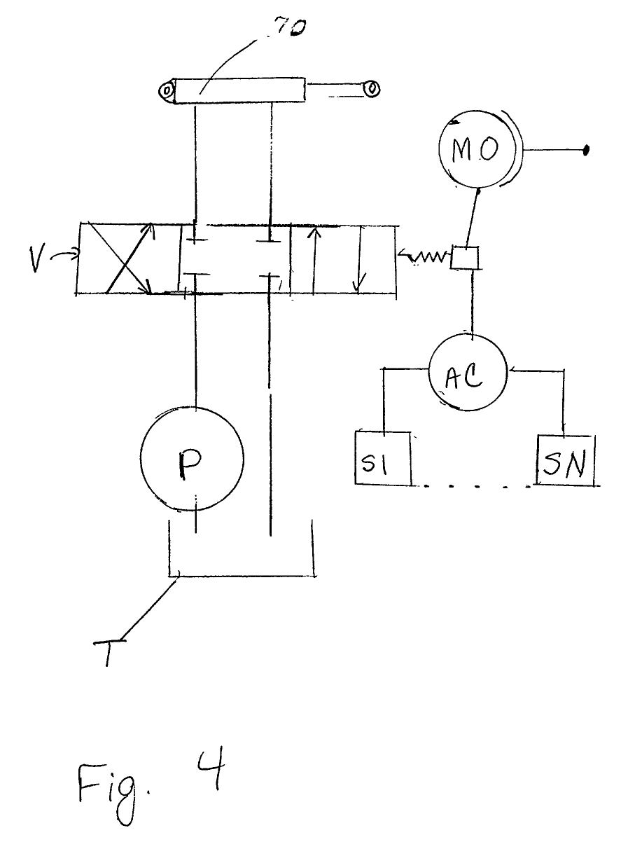

Reference is now made to the drawings which illustrate the apparatus and method and wherein similar reference characters indicate the same parts throughout the several views. Referring now to FIGS. 1 and 4. A preferred embodiment of the invention is built around the following principal components:

1) a tractor 2 having a plurality of wheels 76, 79 and a mechanism 81 that drives at least some of the wheels 76, 79 including:

2) a fifth wheel 50 mounted along a longitudinal axis of the tractor 2;

3) a sensing mechanism S1 . . . SN that senses weight being applied through the fifth wheel 50 and a distribution of weight on the plurality of wheels 76, 79; and

4) an adjustment mechanism 70, AC that adjusts a position of the fifth wheel 50 along the longitudinal axis while the tractor 2 is moving, in response to the sensed weight, to generally equalize the distribution of the weight on the plurality of wheels 76, 79.

Other optional components that may be utilized in conjunction with the tractor 2 may include:

5) devices for seeding 30, fertilizing 20 and tilling 120 hooked together on one apparatus, with the device for seeding 30 mounted immediately behind the device for tilling (or tiller) 120;

6) a device for fertilizing 20 may be used for spreading herbicides;

7) devices for the individual functions may be interchanged with other like devices and combined without changing the basic concept of the invention as described in the claims; and

8) a tiller 120 that is fed by a tube 180 that allows fertilizer to be spread while the soil is being tilled.

Referring now to FIG. 1, a tractor 2, including a cab 80, is disclosed. The tractor 2 includes a front idler wheel 79 and a front drive wheel 76 encircled by a front belt 77 and a plurality of smaller wheels 75 form a front driver 81. Any workable configuration or composition may be used for the front driver 81; a driver for the present invention is not limited to the embodiment shown. The tractor 2 that is preferably, but not necessarily, a substantially horizontal surface 85 for a fifth wheel system 86. A preferred embodiment of the fifth wheel system 86 includes a fifth wheel 50, a fifth wheel support 60 and an hydraulic adjusting device 70. The fifth wheel 50 rides along a rail 110 as the apparatus moves through a field. The hydraulic adjusting device 70 and the rail 110 allows the fifth wheel 50 to change position to compensate for the change in weight distribution as seed and fertilizer are used. The operator would use a lever (not shown) in the cab 80 to move the fifth wheel 50 as the apparatus is moving. The fifth wheel 50 is attached to a hitch 140, which is attached to a longitudinal support 230.

On the hitch 140 is a seed reservoir, or seed tank 90, which stores seed (not shown). Seed flows from the seed tank 90, through the large seed feeding tube 95 to the intermediate seed tank 100. A combination of chemicals and seeds may be in the seed tank. Seed then travels through seeding tubes 35 to a seeder knife 30 before being deposited in the soil as the apparatus is moving.

A reservoir for fertilizer, or fertilizer tank 10, sits on the longitudinal support 230 to the rear of the apparatus along with the pumps 260. A rear idler wheel 161 and a rear drive wheel 160 are encircled by a belt 150 along with various gears 170, comprising a rear driver 145. Any workable composition or configuration of the rear driver 145 may be used. In this preferred embodiment, the rear driver 145 may be steered. On top of the rear tracks or wheels 145 is a rear hitch system 300, which includes a rear fifth wheel 302 and a rear fifth wheel support 304. The rear fifth wheel 302 faces the opposite direction as the fifth wheel 50. The rear fifth wheel 302 is fixed and does not slide. This rear hitch system 300 allows an operator to disengage the rear tracks or wheels 145 from the longitudinal support 230. Disengaging the rear tracks or wheels 145 enables an operator to tow the apparatus from the rear.

Fertilizer (not shown) flows from the fertilizer tank 10 to a fertilizer opener 20 through small fertilizer tubes 25. (One may use a herbicide instead of fertilizer i5 if desired; for brevity, fertilizer shall be used throughout this application.) The fertilizer may be liquid manure. Next to the fertilizer opener 20 is the seeder knife 30. Thus, the fertilizer is being spread right before the seed is deposited. Pumps 260 pump the fertilizer from the fertilizer tank 10 through the fertilizer tube 180 to be spread while a tilling knife 130 tills the soil. The seeder knife 30 is mounted behind the tilling knife 130.

A firming wheel 40 is attached behind the seeder knife 30. The firming wheel 40 rolls on the soil as the apparatus moves. Thus, as the apparatus moves, the tiller 120 tills the soil with a tilling knife 130. The fertilizer opener 20 spreads fertilizer, and the seeder knife 30 drops seed at regular intervals into the tilled soil. The firming wheel 40 packs soil over the seed after the seed and fertilizer are deposited. As shown in FIG. 1 the apparatus introduces fertilizer and seeds into a common open row, but it will be appreciated by those skilled in the art that separate rows may be used if desired.

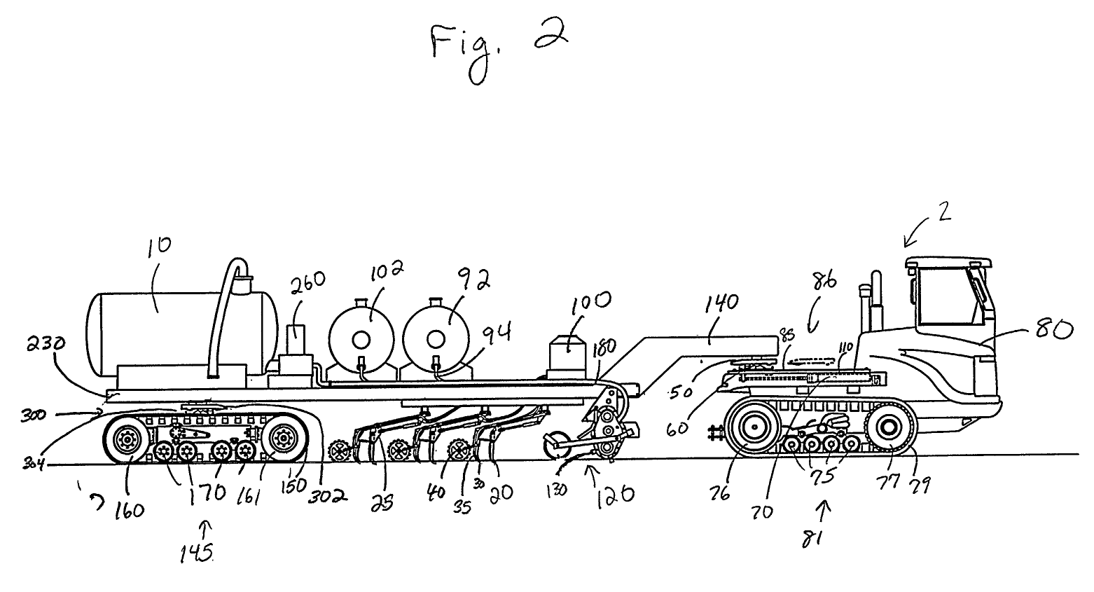

Referring now to FIG. 2, which is a second embodiment of the present invention. An alternative seed tank 92 is connected by an alternative seed tube 94 to the intermediate seed tank 100. A third tank 102 may be connected to the fertilizer opener 20 or the fertilizer tube 180 connected to the tiller 120. One tank may serve as the fertilizer tank 10, and a third tank 102 may contain herbicide or any other chemical. Thus, seed and two chemicals may be tilled and compacted into the soil in one pass. The configuration of tanks on the longitudinal support 230 fails to change the basic operation of the present invention. Components with similar functions may be substituted for other components without changing the concept. All other components in this embodiment are as detailed for FIG. 1.

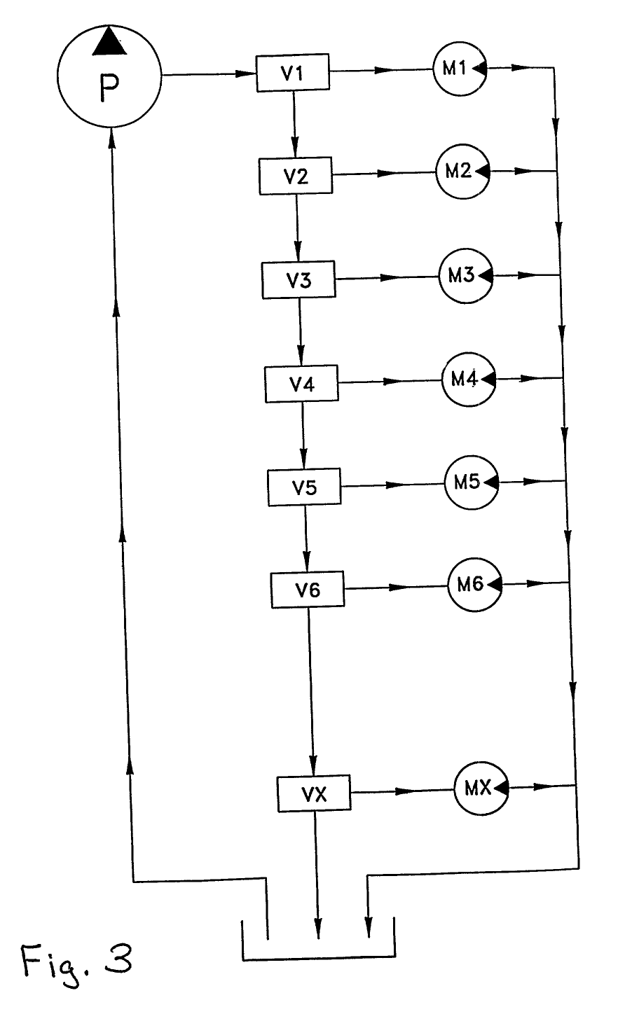

FIG. 3 is a schematic diagram of a hydraulic system for the apparatus. The letter “P” represents a pump feeding into a priority system of pressure compensated flow control valves (V1, V2 through VX). These valves feed motors (M1, M2 through MX). The most important system to the farmer is fed through V1, and the least important is fed through VX. If pressure is lacking, the less important functions drop off, while the most important still operate. For example, one may decide that the motor driving the fifth wheel 50 is the most important. Therefore, V1 would feed the fifth wheel 50 and other valves would feed other functions, such as seeding. This system is shown for clarity. While the system is described with reference to a hydraulic adjusting system, it will be appreciated by those skilled in the art that other conventional mechanisms for relative movement would be effective, for example a system of electric motors and rack-and-pinion gears. Alternatively air motors or air pistons could also be used.

FIG. 4 is a schematic diagram of a hydraulic system for the hydraulic adjusting device 70 for the fifth wheel 50 (FIGS. 1 and 2). This system has a pump P and a tank T. S1 . . . SN are illustrative of multiple sensors on, for example, the fifth wheel (FIGS. 1 and 2) and the wheels 76 and 77. Additional sensors may be located at other locations to provide weight information to the computer hereafter described such as at tank 10. AC is an automatic control, which can control the fifth wheel in real time as hereafter described, and MO is the manual override, for example a lever. The manual override MO is outside the hydraulic circuit, and must be activated by an operator. A valve V controls flow to the hydraulic adjusting device 70. This diagram is shown for clarity only, and any suitable hydraulic or electrical system may be used. The operator can tell by looking at the imprint left by the front tracks 81 that the weight is not being carried evenly by tracks 81 and 145 and can adjust the position of fifth wheel 50 accordingly. However, the apparatus can be instrumented to assist the operator in making this decision. For example, the fifth wheel 50 can be equipped with sensing devices such as transducers, strain gauges and the like, not shown, which can detect changes in the forces applied to the fifth wheel 50 by the attached hitch 140. The detected information can be transmitted to the operator by suitable gauges, also not shown. This information can also be supplied to the on-board computer or microprocessor AC which can operate the hydraulic circuitry in real time (FIG. 4) in response to the information supplied by the sensing devices as known in the art. U.S. Pat. No. 5,677,667 discloses a monitoring system, which may be used for weight shift detection.

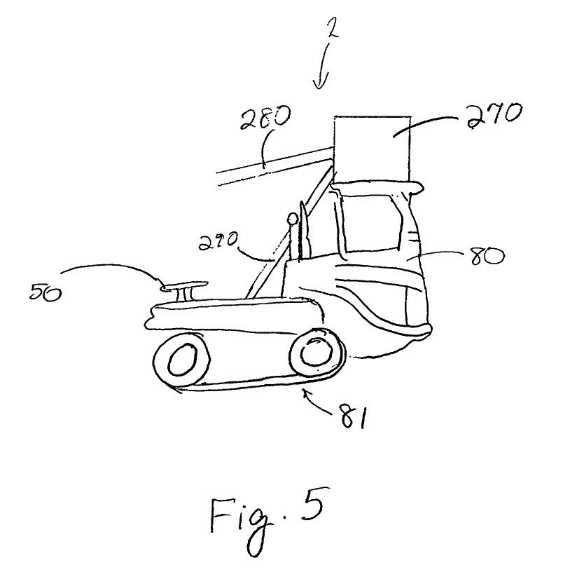

FIG. 5 shows how a container 270 with a container tube 280 and a support 290 may be stored on top of the cab 80. For example, the container 270 is an auxiliary tank for chemicals or fertilizer. The weight in container 270 may require an operator to adjust the fifth wheel 50 while the tractor 2 is in motion, due to the change in weight distribution as the tractor 2 is in use.

Also, the weight in container 270 may cause the front wheels or tracks 81 to dig into the soil under some conditions, causing the apparatus to dig into the soil, and/or unduly compacting the soil. Adjusting the fifth wheel 50, in real-time, in response to sensed weight information enables the operator to counteract those forces.

Operation of the Invention:

To use the tractor 2 to perform a one-pass tilling, seeding and fertilizing operation, an operator fills up the appropriate tanks with chemicals and seed. For example tank 10 as shown in FIG. 1 may contain liquid manure. The seed, such as corn, would be placed in the seed tank 90. When the apparatus has been fully loaded, the hydraulic system for the fifth wheel 50, as shown in FIG. 4, is activated to move the fifth wheel horizontally along the longitudinal axis of the apparatus and evenly distribute the weight. Once this is done the operator drives the apparatus over the soil. While the operator is driving, the tilling apparatus 120 is tilling the soil, chemicals are being applied through the fertilizer opener 20, seed is being deposited by the seeder knife 30, and the seed is being covered by the firming wheel 40. The tilling apparatus 120 is cutting the soil to enable manure to be incorporated into an open row in the soil. Liquid manure is being fed from the fertilizer tank 10 through the small fertilizer tubes 25 to the fertilizer opener 20 and through the fertilizer tube 180, and seed is being fed from the seed tanks 90 through the seed feeding tube 95 to the seeder knife 30. As the manure and seeds are being used, the weight distribution of the apparatus changes. As shown in FIG. 1, the portion of the apparatus carrying tank 10 and having rear tracks 145, and other associated apparatus, will become progressively lighter, and less weight will be transferred to the front portion. The front portion has cab 80, the front tracks 81, and fifth wheel 50. Removing this weight from fifth wheel 50 changes the weight distribution on front tracks 81 and may cause them to dig into the soil and create an unnecessary opportunity for erosion. The present invention changes the weight distribution of the total apparatus in response to weight loss during operation and while the apparatus is in motion. The weight distribution can also be adjusted manually when the operator pushes or pulls a lever in the cab, which moves the fifth wheel 50 to an appropriate location for the weight distribution while the apparatus is being driven. The rails 110 on the fifth wheel 50 allow the fifth wheel 50 to be moved along the longitudinal axis of the tractor 2 to a location to generally distribute the weight between the wheels 76 and 77.

While specific embodiments of the invention have been illustrated and described, this has been done by way of illustration and not as limitation. The invention should not be limited except as required by the scope of the appended claims and their equivalents.

What is claimed is:

1. A tractor having a plurality of wheels and a mechanism that drives at least some of the wheels comprising:
a fifth wheel mounted along a longitudinal axis of the tractor;
a sensing mechanism that senses weight being applied through the fifth wheel and a distribution of weight on the plurality of wheels; and
an adjustment mechanism that adjusts a position of the fifth wheel along the longitudinal axis while the tractor is moving, in response to the sensed weight, to generally equalize the distribution of the weight on the plurality of wheels.

2. An apparatus, having a longitudinal axis, for performing several farming functions in one pass comprising the following:
a cab with an engine;
a component support mechanism having a first end and a second end;
a fifth wheel connected between the cab and the first end of the component support mechanism, wherein the fifth wheel is movable and can change position with an adjusting device along the longitudinal axis of the apparatus while the apparatus is moving;
a first plurality of tracks connected to the cab and a connection mechanism; and
a second plurality of tracks supporting the second end of the component support mechanism, whereby the drivers spread the weight of the apparatus lessening the degree the soil is compacted as the apparatus travels over the soil.

3. The apparatus in claim 2, wherein the wheels or tracks supporting the second end of the means for supporting components may be steered.

4. The apparatus in claim 2, further comprising:
at least one seed reservoir connected to the component support mechanism; and
at least one seed depositing mechanism connected to the component support mechanism.

5. The apparatus in claim 2, further comprising:
at least one chemical reservoir attached to the component support mechanism; and
at least one chemical spreader in communication with the at least one chemical reservoir.

6. The apparatus in claim 2, further comprising at least one soil tilling mechanism attached to the component support mechanism.

7. The apparatus in claim 6, further comprising: at least one chemical storage mechanism attached to the component support mechanism, wherein the at least one chemical spreader in communication with the chemical storage mechanism and attached to the component support mechanism allows the chemical spreader to spread chemical near the soil tilling mechanism.

8. The apparatus in claim 7, further comprising:
at least one reservoir for seed and any chemicals to be deposited with the seed connected to the component support mechanism; and
at least one seed depositing mechanism in communication with the at least one reservoir for seed and any chemicals to be deposited with the seed connected to the component support mechanism.

9. The apparatus in claim 8, wherein the seed depositing mechanism is a rear portion of the soil tilling mechanism.

10. The apparatus in claim 5, wherein the chemical spreader is configured to spread a liquid.

11. The apparatus in claim 5, wherein the chemical spreader is configured for spreading liquid manure.

12. The apparatus in claim 2, wherein the fifth wheel is movable.

13. The apparatus in claim 2, further comprising a means for moving the fifth wheel while the apparatus is moving.

14. The apparatus in claim 2, wherein the adjusting device for moving the fifth wheel includes a lever in the cab connected to at least one hydraulic circuit so that the fifth wheel is moved while the apparatus is moving.

15. The apparatus in claim 2, further including a rear fifth wheel system connected to the tracks and a longitudinal support whereby the tracks may be disengaged and the apparatus is towed from a rear end.

16. The apparatus in claim 1, further including at least one endless track encircling the plurality of wheels.
